(19) United States
(12) Patent Application Publication
(10) Pub. No.: US 2024/0185127 A1
(43) Pub. Date: Jun. 6, 2024

(54) CLIENT MODEL TRAINING METHOD IN DECENTRALIZED LEARNING ENVIRONMENT AND CLIENT DEVICE PERFORMING THE SAME

(71) Applicant: ELECTRONICS AND TELECOMMUNICATIONS RESEARCH INSTITUTE, Daejeon (KR)

(72) Inventor: Seungwon WOO, Daejeon (KR)

(21) Appl. No.: 18/332,974

(22) Filed: Jun. 12, 2023

(30) Foreign Application Priority Data
Dec. 6, 2022 (KR) 10-2022-0168796

(51) Int. Cl. G06N 20/00

(52) U.S. Cl. CPC G06N 20/00

(57) ABSTRACT

Provided is a client model training method in a centralized learning environment. The method includes generating a candidate model by performing learning on the model; transmitting a training result for sharing the candidate model to a plurality of other clients within a critical time; receiving other training results from at least one other client; as the critical time exceeds, performing model consensus on the training result and other training results (hereinafter, all training results) according to a predefined consensus algorithm; and perform an update to the consented model.

### CROSS-REFERENCE TO RELATED APPLICATIONS

This application claims the benefit of the Korean Patent Application No. 10-2022-0168796 filed on Dec. 6, 2022, which is hereby incorporated by reference as if fully set forth herein.

### BACKGROUND

### 1. Field

The present invention relates to a client model training method in a centralized learning environment and a client device performing the same.

### 2. Description of Related Art

Machine learning is a technology that makes a decision on newly given data or generates a model for inference through a training process using data.

However, there is a limitation that it is difficult to guarantee privacy of data of clients in a process of generating an optimal model through machine learning, and thus, there is a problem in that machine learning may not be performed with meaningful data.

Federated learning has been proposed as one way to solve this problem. However, even in this case, as a model is trained by a central server and distributed to a client, there is still a problem in that model performance may be determined according to a degree of participation in learning by the client, and model values dependent on the central server are derived.

### SUMMARY

The present invention provides a client model training method in a centralized learning environment and a client device performing the same capable of deriving an optimal value in a process of iteratively updating a model in a decentralized learning environment, that is, when multiple clients that do not rely on a central server perform training without sharing actual data.

However, the problems to be solved by the present invention are not limited to the problems described above, and other problems may be present.

According to a first aspect of the present invention, a client model training method in a centralized learning environment includes generating a candidate model by performing learning on the model, transmitting a training result for sharing the candidate model to a plurality of other clients within a critical time, receiving other training results from at least one other client, as the critical time exceeds, performing model consensus on the training result and other training results (hereinafter, all training results) according to a predefined consensus algorithm, and performing an update to the consented model.

According to a second aspect of the present invention, a client device performing model training in a decentralized learning environment includes a communication module configured to transmit and receive data to and from other clients in a network, a memory configured to store the model and a program for training the model, and a processor configured to execute the program stored in the memory to transmit a training result for sharing a candidate model generated by performing training on the stored model to a plurality of other clients within a critical time, receive other training results from at least one other client, and perform model consensus on the training result and other training results (hereinafter, all training results) according to a predefined consensus algorithm as the critical time exceeds.

According to another aspect of the present invention for solving the above problems, a computer program executes the client model training method in a centralized learning environment and is stored in a computer readable recording medium.

Other specific details of the invention are included in the detailed description and drawings.

### BRIEF DESCRIPTION OF DRAWINGS

FIG. 1 is a diagram illustrating a process of updating a global model through a local model.

FIG. 2 is a diagram for describing a client device 100 according to an embodiment of the present invention.

FIG. 3 is a flowchart of a client model training method according to an embodiment of the present invention.

FIG. 4 is an overall structural diagram in which the client model training method according to the embodiment of the present invention is performed.

FIG. 5 is a diagram illustrating a candidate model generating step and a model consensus step.

### DETAILED DESCRIPTION

Various advantages and features of the present invention and methods accomplishing them will become apparent from the following description of embodiments with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless otherwise stated, a singular form includes a plural form in the present specification. Throughout this specification, the term “comprise” and/or “comprising” will be understood to imply the inclusion of stated constituents but not the exclusion of any other constituents. Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that the first component mentioned below may be the second component within the technical scope of the present invention.

Unless defined otherwise, all terms (including technical and scientific terms) used in the present specification have the same meanings commonly understood by those skilled in the art to which the present invention pertains. In addition, terms defined in commonly used dictionary are not ideally or excessively interpreted unless explicitly defined otherwise.

Hereinafter, the background to which the present invention was conceived will be described to help those skilled in the art understand, and then the present invention will be described in detail.

There is a method of checking a difference from the desired result by using data of a loss function defined in the model training process and finding an optimal model.

For example, in gradient descent, in order to find a global minimum which is a minimum in the loss function, a process of calculating a gradient through differentiation and updating a model is repeated. In this case, the model is also called a weight.

This process may be expressed as Equation 1 below.

Wᵢ=Wᵢ₋₁−αΔWᵢ₋₁ [Equation 1]

Equation 1 shows a process of updating from an i−1-th weight (wᵢ₋₁) to an i-th weight (wᵢ), and means determining an update degree through a gradient (Δwᵢ₋₁) obtained by differentiating the loss function and a learning rate (α) to update to the next weight.

However, in the process of finding an optimal model, there is a problem in that the value of the loss function may fall into a local minimum in a specific section. In particular, when the model is large and the loss function is a complex non-convex function, there may be the global minimum that records a smaller value when the loss function is calculated. Therefore, the training may be variously performed by adjusting hyperparameters (a kind of constants determined during the training process) such as the learning rate that determines how much to update the model.

However, for problems that are difficult to infer, it is difficult to find a model value corresponding to the actual global minimum, or to prove that the model value actually corresponds to the global minimum even if found.

In this regard, the present invention targets a training process of developing an existing model and finding an optimal model through the iterative updating.

Meanwhile, another one of the problems of machine learning is that it is difficult to protect privacy of client's data in that a central server holds and learns all the data used for learning.

Also, since the client does not provide meaningful data necessary for training due to privacy issues, there are some limitations in generating a high-performance model.

To solve this problem, a federated learning technology is attracting attention. The federated learning is a training method in which the central server communicates with multiple clients and finds an optimal model without sharing actual data.

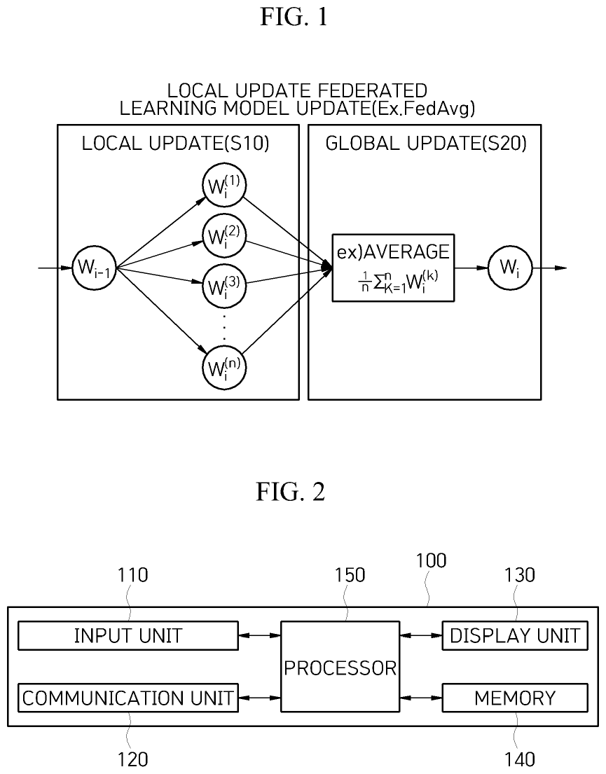

FIG. 1 is a diagram illustrating a process of updating a global model through a local model.

The federated learning is largely divided into an Initialization step, a local update step (S10), and a global update step (S20), and the local update step (S10) and the global update step (S20) are repeated to find the optimal model value.

For example, in the case of the gradient descent, which finds the optimal value by iteratively updating the model, the central server generates or updates a model in an initialization step and transmits the generated or updated model to the client. In this case, the model that the central server manages is called as a global model.

In the local update step (S10), the training is performed based on the global model using data that each client has, and the training result is transmitted to the central server. In this case, the training result transmitted by each client may be a gradient derived through the differentiation of the loss function, and a model directly created by updating the global model received from the central server using the gradient (S20). In this case, the model that the client performs training and manages is called a local model.

Finally, in the global update step (S20), the initially transmitted global model is updated by collecting gradients or local model values transmitted from a plurality of clients (usually assigning weights or obtaining an average).

In this regard, the global update process (S20) through the received gradient is expressed as Equation 2 below.

Wᵢ=Wᵢ₋₁−α1/NΣₖ₌₁^{N}ΔWᵢ₋₁^{(k)} [Equation 2]

Equation 2 shows the process of global updating (S20) from the i−1-th model (wᵢ₋₁) to the i-th model (wᵢ), and means determining an average value obtained by collecting data of each of a total of N clients and a gradient (ΔWᵢ₋₁^{(j)}, gradient of a k-th client) obtained by differentiating the loss function and the learning rate (ca) to update to the next weight.

In addition, the process of updating (S20) through the received local model is expressed as Equation 3 below.

Wᵢ=1/NΣₖ₌₁^{N}Wᵢ(k) [Equation 3]

Equation 3 shows the process of global updating from the i−1-th model (wᵢ₋₁) to the i-th model (wᵢ) (S20), and the global model is updated by a method in which each client transmits the local model ΔWᵢ₋₁^{(k)} generated through the local update process (Wᵢ^{(k)}=Wᵢ₋₁−αΔWᵢ₋₁^{(k)}, Equation for obtaining the gradient ΔWᵢ₋₁^{(k)} at the k-th client and updating the local model Wᵢ^{(k)}) and collects the corresponding values to obtain the average. The process of updating the global model through the received local model is as illustrated in FIG. 1.

However, since the client manages the training data, the general federated learning method may hold data that is not suitable for learning and affect the learning speed. In addition, the calculation result of the loss function may fall into the local minimum because other clients offset the local update result of the client having good quality data. Finally, there is a problem in that the model values dependent on the central server are derived as the central server finally determines the update method during the global update process.

In order to solve this problem, an embodiment of the present invention may derive an optimal value during a process of iteratively updating a model while training without sharing actual data by a plurality of clients in the decentralized learning environment that is out of the existing centralized federated learning structure.

Hereinafter, a client device 100 performing model training in a decentralized learning environment according to an embodiment of the present invention will be described with reference to FIG. 2.

FIG. 2 is a diagram for describing the client device 100 according to the embodiment of the present invention.

The client device 100 according to the embodiment of the present invention includes an input unit 110, a communication unit 120, a display unit 130, a memory 140, and a processor 150.

The input unit 110 generates input data in response to a user input of the client device 100. The user input may include the user input related to data that the client device 100 intends to process.

The input unit 110 includes at least one input means. The input unit 110 may include a keyboard, a key pad, a dome switch, a touch panel, a touch key, a mouse, a menu button, and the like.

The communication unit 120 serves to transmit and receive data between internal components or communicate with an external device such as an external server. That is, the communication unit 120 may transmit and receive data between a plurality of client devices or to and from the central server as needed. The communication unit 120 may include both a wired communication module and a wireless communication module. The wired communication module may be implemented as a power line communication device, a telephone line communication device, cable home (MoCA), Ethernet, IEEE1294, an integrated wired home network, and an RS-485 control device. In addition, the wireless communication module may be configured in a module for implementing functions such as wireless LAN (WLAN), Bluetooth, HDR WPAN, UWB, ZigBee, Impulse Radio, 60 GHz WPAN, Binary-CDMA, wireless USB technology and wireless HDMI technology, 5th (5G) generation communication, long term evolution-advanced (LTE-A), long term evolution (LTE), and wireless fidelity (Wi-Fi).

The display unit 130 displays display data according to the operation of the client device 100. The display unit 130 may include a liquid crystal display (LCD), a light emitting diode (LED) display, an organic LED (OLED) display, a micro electro mechanical systems (MEMS) display, and an electronic paper display. The display unit 130 may be coupled with the input unit 110 and implemented as a touch screen.

The memory 140 stores models for which training has been completed, and also stores programs for model training. Here, the memory 140 collectively refers to a non-volatile storage device that continuously maintains stored information even when power is not supplied and a volatile storage device. For example, the memory 140 may include NAND flash memories such as a compact flash (CF) card, a secure digital (SD) card, a memory stick, a solid-state drive (SSD), and a micro SD card, magnetic computer storage devices such as a hard disk drive (HDD), and optical disc drives such as CD-ROM and DVD-ROM.

The processor 150 may execute software such as a program to control at least one other component (e.g., hardware or software component) of the client device 100, and may perform various data processing or calculations.

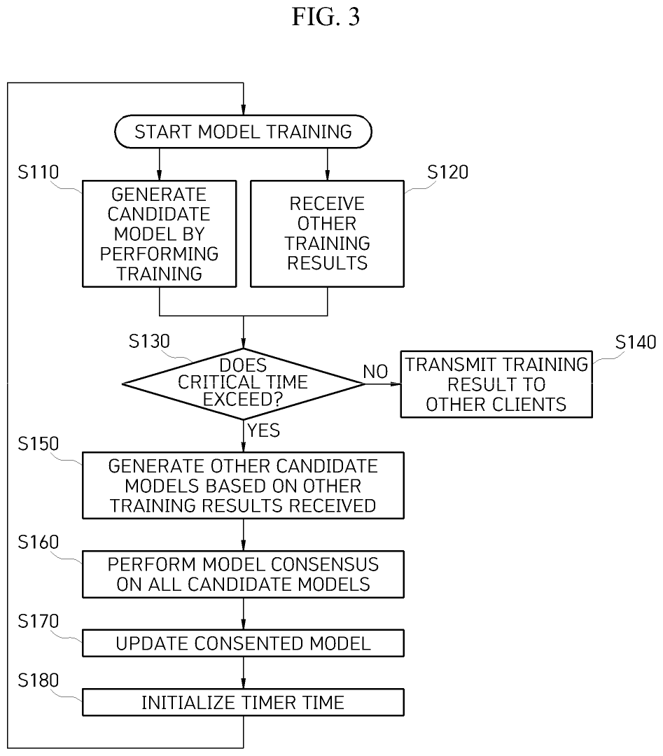

Hereinafter, the client model training method in a centralized learning environment performed by the client device 100 will be described with reference to FIGS. 3 to 5.

An embodiment of the present invention proposes a client model update method in a decentralized learning environment. In this case, the decentralized learning environment means a learning environment in which multiple clients derive an optimal model through the same interference goal without the central server.

In one embodiment of the present invention, the decentralized learning environment assumes or premises the following situation.

First, all clients participating in training need to be able to transmit and receive data directly or indirectly through the network.

Second, any client may upload/download specific data using a distributed storage such as InterPlanetary File System (IPFS) to transmit data. When there is no distributed storage, it should be possible to store and manage data transmitted and received over the network.

Third, all clients should have access to the distributed storage and have a location to download and upload models. In addition, to reduce the size of the model, compressed models or gradients may be stored in distributed storage or private storage. In this case, a function of getting the actual model based on the compressed model, a function of storing the last updated model, etc., are required.

Fourth, it is assumed that all clients should have predefined setting information such as a data format and a model format that should be defined in advance before the training process, and that setting information is shared through a network or distributed storage. Each client may perform a preprocessing operation prior to training based on the shared setting information. For example, in the case of the data format, feature vectors to be used as inputs are extracted from the holding data, and when supervised learning is aimed at, labeling matching the supervised learning is also performed. In addition, even in the case of the model format, it should be defined in advance before training a convolutional neural network (CNN), multi-layer perceptron, etc. A loss function to be applied iteratively in training may also be defined and included in this setting information.

The present invention satisfies the decentralized learning environment, and performs the iterative updating of the model through the consensus algorithm in the situations where the model is iteratively updated to find the optimal value, such as the gradient descent, without sharing the learning data held by the client.

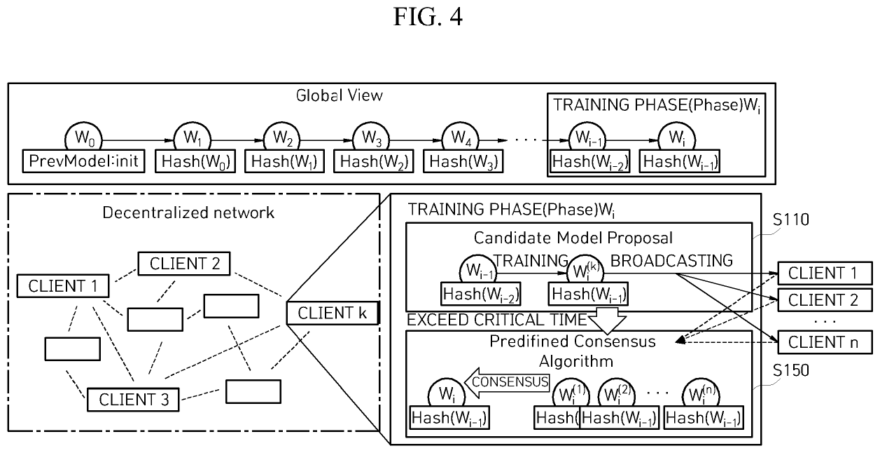

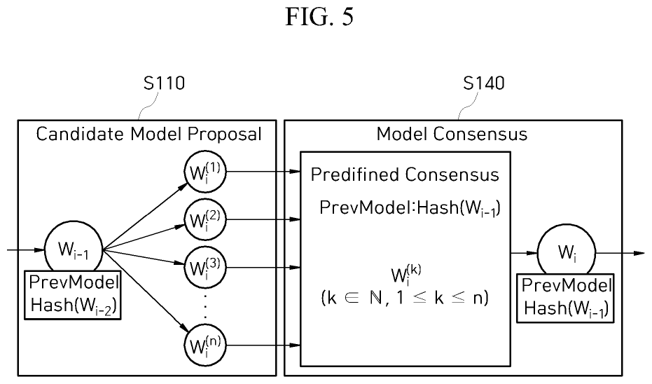

FIG. 3 is a flowchart of a client model training method according to an embodiment of the present invention. FIG. 4 is an overall structural diagram in which the client model learning method according to the embodiment of the present invention is performed. FIG. 5 is a diagram illustrating a candidate model generating step and a model consensus step.

In an embodiment of the present invention, the client first generates a candidate model by performing the training on the model (S110).

The candidate model generating step is the process of generating the i-th candidate model through the training process targeting the i1th (i is a natural number) model consented lastly when the client generates the candidate model. That is, the candidate model generating step is the process in which the client participating in training performs training on the model consented lastly to derive the optimal result in the critical time. For example, in the case of the gradient descent, the optimal result may be a gradient or a model.

Each client aims to find the optimal model value with high accuracy by maximally using resources held in the training process and finding the optimal hyperparameter. For example, the optimal model value may be found by adjusting the learning rate or through generalization.

Alternatively, when the current learning direction is suspected to be the local minimum rather than the global minimum, a completely new learning direction may be proposed by greatly changing the direction.

In the process of generating a candidate model, the client should specify the previously consented model when proposing a candidate model. For example, the client may specify the hash value for the i−1 th model consented lastly through a hash function.

The candidate models proposed in this way are consented as a single model in the model consensus step described later.

Next, the client receives other training results from at least one other client within the critical time (S120). In this case, the training result or other training results may be the candidate model itself or the gradient obtained by differentiating the loss function.

In addition, the client checks whether the critical time has exceeded (S130), and transmits the training result for sharing the candidate model to a plurality of other clients within the critical time (S140).

The clients in the network may transmit or receive the generated training result (candidate model or gradient) to other clients within a predefined critical time through a timer, and when the critical time elapses, may transmit the training results. Accordingly, in one embodiment of the present invention, a client may transmit other training results received from at least one other client to other clients that have not received at least one of all the training results.

Then, as the critical time elapses, other candidate models may be generated based on other training results received from other clients (S150). Here, the generated other candidate models means itself when other candidate models are directly received as other training results, or means generating other candidate models through the gradient information when the gradient information is received as other training results.

Wᵢ=Wᵢ₋₁−ΔWᵢ₋₁^{(k)} [Equation 4]

In this case, Equation 4 is to update from the i−1-th weight (wᵢ₋₁) to the i-th weight (wᵢ), and in this process, the gradient information obtained by differentiating the loss function of the k-th client is used.

Thereafter, the client performs the model consensus on all the training results including the training result and other training results through the predefined consensus algorithm (S160), and performs an update to the consented model (S170).

In the model consensus step, the candidate models proposed by multiple clients are consented as a single model through the predefined consensus algorithm, and the lastly consented model is updated to the latest model. The model consensus step corresponds to the global update step in the federated learning, and the consented model may be viewed as the global model.

In this case, the consensus algorithm used to consent a plurality of candidate models as a single model in the present invention may be defined and included in the above-described setting information.

As an embodiment, in the present invention, the model consensus may be performed based on data existing in any one of a plurality of clients that is selected as a leader.

Specifically, after a leader client is selected from a plurality of clients according to a round-robin method, data existing in the leader client is configured as a test set.

Then, the accuracy of all the candidate models may be checked based on the test set, and the model consensus may be performed with a candidate model with highest accuracy.

As another embodiment, in the present invention, the model consensus may be performed based on a test set configured by clients in a group configured according to a predetermined condition among a plurality of clients.

Specifically, a group including a client that proposes a candidate model among a plurality of clients may be configured. Next, a test set including noise is configured by each client in a group, and the accuracy of all the candidate models is calculated based on the test set and shared with clients, so the model consensus may be performed based on the accuracy. In this case, the model consensus may be performed by a majority vote result by clients based on accuracy.

As such, unlike other methods of collecting, averaging, or weighting the results transmitted by clients in the global update step of the existing federated learning to perform the update, an embodiment of the present invention has a difference in that the model is updated by defining the consensus algorithm in advance and consenting the candidate models as a single model.

This model consensus process is expressed as Equation 4 below.

Wᵢ=PredefinedConsensus(Wᵢ⁽¹⁾,Wᵢ⁽²⁾, . . . ,Wᵢ⁽ⁿ⁾) [Equation 5]

Equation 5 means that n candidate models proposed in the i-th model update process are updated by consenting as a single model through a predefined algorithm.

Meanwhile, when the model update ends, the timer time is initialized and the next model training starts (S180).

Meanwhile, in the above description, steps S110 to S180 may be further divided into additional steps or combined into fewer operations according to an implementation example of the present invention. Also, some steps may be omitted if necessary, and an order between the steps may be changed. In addition, other omitted contents may also be applied to the contents described in FIG. 2 and the contents described in FIGS. 3 to 5, respectively.

The client model training method in a centralized learning environment according to the embodiment of the present invention described above may be implemented as a program (or application) and stored in a medium to be executed in combination with a computer that is hardware.

In order for the computer to read the program and execute the methods implemented as the program, the program may include a code coded in a computer language such as C, C++, JAVA, Ruby, or machine language that the processor (CPU) of the computer may read through a device interface of the computer. Such code may include functional code related to a function or such defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions is to be referenced at. In addition, when the processor of the computer needs to communicate with any other computers, servers, or the like located remotely in order to execute the above functions, the code may further include a communication-related code for how to communicate with any other computers, servers, or the like using the communication module of the computer, what information or media to transmit/receive during communication, and the like.

The storage medium is not a medium that stores images therein for a while, such as a register, a cache, a memory, or the like, but means a medium that semi-permanently stores the images therein and is readable by an apparatus. Specifically, examples of the storage medium include, but are not limited to, ROM, random-access memory (RAM), CD-ROM, a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

The above description of the present invention is for illustrative purposes, and those skilled in the art to which the present invention pertains will understand that it may be easily modified to other specific forms without changing the technical spirit or essential features of the present invention. Therefore, it should be understood that the above-mentioned exemplary embodiments are exemplary in all aspects but are not limited thereto. For example, each component described as a single type may be implemented in a distributed manner, and similarly, components described as distributed may be implemented in a combined form.

According to an embodiment of the present invention, unlike general federated learning that depends on a central server, it is possible to update a model through a consensus algorithm without relying on a central server in a decentralized learning environment.

In particular, according to an embodiment of the present invention, unlike the existing federated learning which simply aggregates and averages models provided by clients, by adopting a method of performing consensus with one of candidate models proposed through a consensus algorithm, it is possible to significantly increase the contribution of clients who have good quality data to help learning.

In addition, according to an embodiment of the present invention, it is possible to check the entire process of updating models by linking models using a hash function or the like and managing the models in a chain format, and to use the checked process for transparent and fair incentive payment to clients who participate in learning later.

The effects of the present invention are not limited to the above-described effects, and other effects that are not mentioned may be obviously understood by those skilled in the art from the following description.

It is to be understood that the scope of the present invention will be defined by the claims rather than the above-described description and all modifications and alternations derived from the claims and their equivalents are included in the scope of the present invention.

What is claimed is:

1. A client model training method in a centralized learning environment, the client model training method comprising:
generating a candidate model by performing learning on the model;
transmitting a training result for sharing the candidate model to a plurality of other clients within a critical time;
receiving other training results from at least one other client;
as the critical time exceeds, performing model consensus on the training result and other training results (hereinafter, all training results) according to a predefined consensus algorithm; and
performing an update to the consented model.

2. The client model training method of claim 1, wherein, in the generating of the candidate model by training the model, an i-th candidate model is generated through a training process for a i−1-th (i is a natural number) model consented lastly.

3. The client model training method of claim 1, wherein the generating of the candidate model by performing the model includes specifying a hash value for the i−1-th model consented lastly through a hash function.

4. The client model training method of claim 1, further comprising:
transmitting other training results received from the at least one other client to other clients that have not received at least one of all the training results.

5. The client model training method of claim 1, wherein, in the performing of the model consensus on all the training results according to the consensus algorithm, the model consensus is performed based on data existing in any one of the plurality of clients that is selected as a leader.

6. The client model training method of claim 5, wherein the performing of the model consensus on all the training results according to the consensus algorithm includes:
selecting any one of the plurality of clients as the leader according to a round robin method;
configuring data existing in a client as a test set according to being selected as the leader;
checking accuracy of all candidate models based on the test set; and
performing the model consensus with a candidate model with highest accuracy.

7. The client model training method of claim 1, wherein, in the performing of the model consensus on all the training results according to the consensus algorithm, the model consensus is performed based on a test set configured by a client in a group configured according to a predetermined condition among the plurality of clients.

8. The client model training method of claim 7, wherein, in the performing of the model consensus on all the training results according to the consensus algorithm, a group including a client proposing a candidate model among the plurality of clients is configured, the test set including noise by each of the clients in the group is configured, and as accuracy of all candidate models is calculated based on the test set and shared with clients in the group, the model consensus is performed based on the accuracy.

9. A client device performing model training in a decentralized learning environment, the client device comprising:
a communication module configured to transmit and receive data to and from other clients in a network;
a memory configured to store the model and a program for training the model; and
a processor configured to execute the program stored in the memory to transmit a training result for sharing a candidate model generated by performing training on the stored model to a plurality of other clients within a critical time, receive other training results from at least one other client, and perform model consensus on the training result and other training results (hereinafter, all training results) according to a predefined consensus algorithm as the critical time exceeds.

10. The client device of claim 9, wherein the process generates an i-th candidate model through a training process for a i−1-th (i is a natural number) model consented lastly.

11. The client device of claim 9, wherein the process specifies a hash value for the i−1-th model consented lastly through a hash function.

12. The client device of claim 9, wherein the process transmits other training results received from the at least one other client to other clients that have not received at least one of all the training results.

13. The client device of claim 9, wherein the process performs the model consensus based on data existing in any one of the plurality of clients that is selected as a leader.

14. The client device of claim 13, wherein the process selects any one of the plurality of clients as the leader according to a round robin method, configures data existing in a client as a test set according to being selected as the leader, checks accuracy of all candidate models based on the test set, and performs the model consensus with a candidate model with highest accuracy.

15. The client device of claim 9, wherein the process performs the model consensus based on a test set configured by a client in a group configured according to a predetermined condition among the plurality of clients.

16. The client device of claim 15, wherein the process configures a group including a client proposing a candidate model among the plurality of clients, configures the test set including noise by each of the clients in the group, and calculates an accuracy of all candidate models based on the test set and shared with clients in the group, and the model consensus is then performed based on the accuracy.
